(19) United States
(12) Patent Application Publication
(10) Pub. No.: US 2026/0189582 A1
(43) Pub. Date: Jul. 2, 2026

(54) ANOMALY IDENTIFICATION USING FUZZY-MATCH BASED ACCOUNT LINKING

(71) Applicant: Walmart Apollo, LLC, Bentonville, AR (US)

(72) Inventors: Saurabh Paul, Fremont, CA (US); Hui-Min Chen, Pleasanton, CA (US)

(21) Appl. No.: 19/005,192

(22) Filed: Dec. 30, 2024

(51) Int. Cl. H04L 9/40; G06N 3/043

(52) U.S. Cl. CPC H04L 63/1425; G06N 3/043; H04L 63/10; H04L 63/1441

(57) ABSTRACT

Example implementations relate to anomaly detection in a network environment. In an example, a similarity score for one or more attributes between a target user and a candidate user is calculated based on n-grams generated from the one or more attributes. Link data linking the target user to the first candidate user for the first attribute is generated if the similarity score between the target user and the first candidate user is greater than a first threshold. A machine learning model that identifies a likelihood whether the target user is linked to a terminated entity based on the one or more attributes is trained using the link data. The machine learning model applies respective weights to each of the one or more attributes. The respective weights associated with the one or more attributes is updated based on feedback data associated with changes in operating permissions within a predetermined time period.

### TECHNICAL FIELD

This application relates generally to automated anomaly detection, and more particularly, to automated anomaly detection in network environments.

### BACKGROUND

Users of a network environment who engage in behavior that does not meet standards of the network environment (e.g., risky, dishonest, and/or fraudulent behavior) may be terminated to safeguard other legitimate users of the network environment. Some previously terminated users attempt to regain access to the network environment by masquerading as a new user.

### BRIEF DESCRIPTION OF THE DRAWINGS

Various examples will be described below with reference to the following figures.

FIG. 1 is a block diagram of an example anomaly detection system, in accordance with some embodiments.

FIG. 2 is a schematic diagram of a feedback flow of an example anomaly detection system, in accordance with some embodiments.

FIG. 3 is a block diagram of example machine learning models used in an anomaly detection system, in accordance with some embodiments.

FIG. 4 is a diagram showing example linkages of a target user, in accordance with some embodiments.

FIG. 5 is a schematic diagram of different components in an anomaly detection system, in accordance with some embodiments.

FIG. 6 is a flowchart illustrating an example anomaly detection method, in accordance with some embodiments.

FIG. 7 is an example machine-readable storage medium, in accordance with some embodiments.

FIG. 8 depicts a block diagram of an example anomaly detection computing device, in accordance with some embodiments.

### DETAILED DESCRIPTION

The disclosed systems and methods provide an anomaly detection or anomaly identification process that utilizes a machine learning model to learn representations of similar or semantically similar attributes associated with users of a network environment. A user may perform operations or transactions in a network environment after registering on the network environment. For example, the network environment may include an ecommerce platform on which users may list items for sale, or buy items offered by sellers. Users of a network environment who engage in behavior that does not meet standards of the network environment (e.g., risky, dishonest, and/or fraudulent behavior) may be terminated to safeguard legitimate users of the network environment. Some previously terminated users attempt to regain access to the network environment by masquerading as new users who are in fact proxies or associates of such terminated users. A terminated user and/or network environment activity thereof may also be referred to hereinafter as an anomaly. The detection of terminated users who are masquerading as new users to regain access to the network environment may also be referred hereinafter as “anomaly detection,” or “anomaly identification.”

An anomaly may be identified and/or detected based on a determination that one or more attributes of a target user are likely linked to one or more previously terminated or suspended users. The ability to update, based on feedback data, respective weights associated with various attributes of the user for computing a riskiness score may allow the anomaly detection system to be responsive to emerging trends, improving the accuracy of anomaly detection and may help to better safeguard users in the network environment.

In various embodiments, a system including a processor and a non-transitory memory storing instructions is disclosed. The instructions, when executed, cause the processor to calculate a similarity score for one or more attributes between a target user and one or more candidate users based on n-grams generated from the one or more attributes. The instructions further cause the processor to determine whether the similarity score between the target user and a first candidate user of the one or more candidate users for a first attribute of the one or more attributes is greater than a first threshold. In response to determining that the similarity score between the target user and the first candidate user is greater than the first threshold, the instructions further cause the processor to generate link data that links the target user to the first candidate user for the first attribute. The instructions further cause the processor to train a machine learning model using the link data. The machine learning model identifies a likelihood whether the target user is linked to a terminated entity based on the one or more attributes, and the machine learning model applies respective weights to each of the one or more attributes. The instructions further cause the processor to update the respective weights associated with the one or more attributes based on feedback data associated with changes in operating permissions within a predetermined time period. In response to a determination, based on the updated respective weights, that the likelihood of the target user being linked to the terminated entity exceeds a second threshold indicating that an anomaly has been detected, the instructions further cause the processor to modify one or more operating permissions associated with the target user within a network environment.

In various embodiments, a computer-implemented method is disclosed. The computer-implemented method includes steps of calculating a similarity score for one or more attributes between a target user and one or more candidate users based on n-grams generated from the one or more attributes. The computer-implemented method further includes steps of determining whether the similarity score between the target user and a first candidate user of the one or more candidate users for a first attribute of the one or more attributes is greater than a first threshold. In response to determining that the similarity score between the target user and the first candidate user for the first attribute is greater than the first threshold, the computer-implemented method further includes steps of generating link data that links the target user to the first candidate user for the first attribute and training a machine learning model using the link data. The machine learning model identifies a likelihood whether the target user is linked to a terminated entity based on the one or more attributes. The machine learning model applies respective weights to each of the one or more attributes. The computer-implemented method further includes steps of updating the respective weights associated with the one or more attributes based on feedback data associated with changes in operating permissions within a predetermined time period. In response to a determination, based on the updated respective weights, that a likelihood of the target user being linked to the terminated entity exceeds a second threshold indicating that an anomaly has been detected, the computer-implemented method further includes steps of modifying one or more operating permissions associated with the target user within a network environment.

In various embodiments, a non-transitory computer-readable medium having instructions stored thereon is disclosed. The instructions, when executed by at least one processor, cause at least one device to perform operations including calculating a similarity score for one or more attributes between a target user and one or more candidate users based on n-grams generated from the one or more attributes. The instructions further cause the at least one device to perform operations including determining whether the similarity score between the target user and a first candidate user of the one or more candidate users for a first attribute of the one or more attributes is greater than a first threshold. In response to determining that the similarity score between the target user and the first candidate user for the first attribute is greater than the first threshold, the instructions further cause the at least one device to perform operations including generating link data that links the target user to the first candidate user for the first attribute, and training a machine learning model using the link data. The machine learning model identifies a likelihood whether the target user is linked to a terminated entity based on the one or more attributes. The machine learning model applies respective weights to each of the one or more attributes. The instructions further cause the at least one device to perform operations including updating the respective weights associated with the one or more attributes based on feedback data associated with changes in operating permissions within a predetermined time period. In response to a determination, based on the updated respective weights that a likelihood of the target user being linked to the terminated entity exceeds a second threshold indicating that an anomaly has been detected, the instructions further cause the at least one device to perform operations including modifying one or more operating permissions associated with the target user within a network environment.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for anomaly detection. In various embodiments, the methods and systems described herein are capable of using a machine learning model to learn representations of similar or semantically similar attributes associated with users of a network environment. The ability to compute a riskiness score by updating respective weights associated with various attributes of the users based on feedback data may allow the anomaly detection system to be responsive to emerging trends, improving the accuracy of anomaly detection, and may help to better safeguard users in the network environment.

Various attributes of a user may be provided to the network environment as a part of a registration or onboarding process in order to be granted access to the network environment. The various attributes may include personally identifiable information or other information associated with the user. Examples of such attributes may include tangible attributes such as name, email, address, and business name, or intangible attributes such as listing information, customer dispute information, and item category of items that are listed for sale. A user may also have multiple emails and addresses. For example, a first email may be used for receiving payments from the network environment, a second email may be used for login purposes, and/or a third email may be used to check inventory. A user may also have multiple addresses, such as an address used for incorporating the user's business, an address associated with a warehouse that stores the user's items for sale, an address associated with a return center, or a payee address. Some attributes may be more relevant for anomaly detection (e.g., due to the inherent riskiness associated with some attributes that may be less significant for other attributes).

In some instances, a previously terminated user may attempt to re-register as a new user on the network environment and be rejected at the registration stage. As a result, the previously terminated user may then create multiple versions of an original (e.g., rejected) email address by changing one letter or digit and attempt to register for a new account using the manipulated information to circumvent system safeguards of the network environment. As another example, anomalous parties from geographical regions that are banned from accessing the network environment may attempt to register as a user in the network environment using a US address using a changed or manipulated PO box number. In some embodiments, a fuzzy-match based account-linking system may be better suited to account for such data manipulations and may achieve better anomaly detection than systems that search for exact matches of attributes of a previously terminated user.

The disclosed systems and methods of anomaly detection assess a user's riskiness (e.g., likelihood to be associated with a previously terminated user, and/or likelihood to be engaged in behavior on the network environment that do not meet standards of the network environment) based on the user's linkage to other users in the network environment. In some embodiments, the linkage between a pair of users in the network environment (e.g., a target user and another user in the network environment) may be based on fuzzy matching of one or more attributes between the pair of users. A strength of the linkage or the relationship between the pair of users may be identified using the disclosed methods and systems and may include one or more of the following: data transformation, encoding, semantic learning, and aggregation.

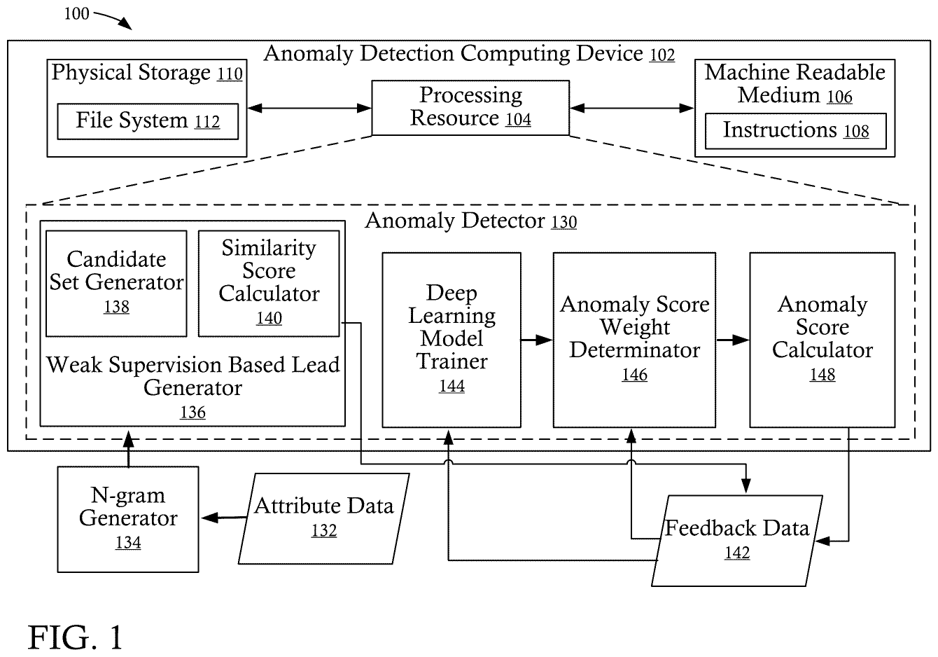

FIG. 1 depicts an example system 100 that implements anomaly detection, in accordance with some embodiments. System 100 includes an anomaly detection computing device 102 that determines whether a target user may be associated with any previously terminated users and provides an output (e.g., a score) indicative of the riskiness of the target user. The anomaly detection computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The anomaly detection computing device 102 includes a non-transitory machine-readable medium 106 that may include one or more of a random-access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the anomaly detection computing device 102, such as calculating a similarity score for one or more attributes between a target user and one or more candidate users based on n-grams generated from the one or more attributes, generating link data that links the target user to a first candidate user for the first attribute in response to determining that the similarity score between the target user and the first candidate user is greater than a first threshold, training a machine learning model using the link data, training a second machine learning model to learn the respective weights and/or updating respective weights associated with the one or more attributes based on feedback data associated with changes in operating permissions within a predetermined time period. The instructions 108 may include instructions for implementing one or more models. In some embodiments, and as will be described further herein below, the anomaly detection computing device 102 may execute one or more models, processes, or algorithms, such as a machine learning model, deep learning model, statistical model, etc., (e.g., as implemented as machine readable instructions) to detect an anomaly.

The anomaly detection computing device 102 may also include other hardware components, such as physical storage 110. Physical storage 110 may include any physical storage device, such as a hard disk drive, a solid-state drive, or the like, or a plurality of such storage devices (e.g., an array of disks), and may be locally attached (e.g., installed) in the anomaly detection computing device 102. In some implementations, physical storage 110 may be accessed as a block storage device.

In some cases, the anomaly detection computing device 102 may also include a local file system 112 that may be implemented as a layer on top of the physical storage 110. For example, an operating system may be executing on the anomaly detection computing device 102 (by virtue of the processing resource 104 executing certain instructions 108 related to the operating system) and the operating system may provide a file system 112 to store data on the physical storage 110.

The anomaly detection computing device 102 may be in communication with one or more additional devices over one or more network channels. For example, in various embodiments, the anomaly detection computing device 102 may be in communication with a web server, a cloud-based engine including one or more processing devices that may be provisioned for use, a database, a workstation, and/or any other suitable system or device. The anomaly detection computing device 102 may similarly be in communication, either directly or indirectly, with one or more user computing devices operatively coupled over the network. The other computing systems may be similar to the anomaly detection computing device 102 and may each include at least a processing resource and a machine-readable medium.

In some embodiments, the anomaly detection computing device 102, such as the processing resource 104, includes an anomaly detector 130 that has a weak supervision-based lead generator 136. Attribute data 132, including tangible attributes and/or intangible attributes described above (e.g., name, email, address, business name or listing information, etc.), is processed through an n-gram generator 134 to generate n-grams (e.g., tri-grams) that are provided as input data to the weak supervision-based lead generator 136. Although the n-gram generator 134 is illustrated external to the anomaly detection computing device 102, it will be appreciated that the n-gram generator 134 may be implemented by the anomaly detection computing device 102 in some embodiments. The weak supervision-based lead generator 136 identifies potential fuzzy match leads for a target user based on one or more attributes of the target user (e.g., received as n-grams after the one or more attributes are processed by the n-gram generator 134).

The potential leads (e.g., linkage between users) may be identified based on a single attribute or multiple attributes. For example, a single attribute may be a name, an email, an address, or a business name. In some embodiments, multiple attributes are used to identify potential leads. For example, the multiple attributes may be “name and email,” “email and address,” “address and business name,” etc. The weak supervision-based lead generator 136 implements and/or includes one or more of: data cleaning, tokenization, reverse indexing based on character n-grams from the n-gram generator 134, a candidate-set generator 138, and/or a similarity score calculator 140.

Attribute data 132 of users in the network environment and/or the target user may be pre-processed, for example as part of a batch or offline process. Pre-processing of the attribute data 132 may include converting uppercase text into lowercase, and/or removing special characters and/or whitespace. Tokens may be generated from the cleaned text. In some instances, attribute data 132, such as emails, may be split into tokens based on characters such as “@”, “.”, “_”, “+”, and/or “−”. The split text may be checked to determine if numbers are followed by letters or vice-versa. In some embodiments, the text may be further split at every phase change (e.g., change from numbers to letters, or change from letters to numbers). As an example, an email address such as admin101@emaildomain.com may be split into tokens such as “admin”, “101”, “emaildomain”, and “com”. For addresses having a general format of “street1, street2, city, zip,” the different fields of the address may be concatenated into a string to form a token.

Pre-processing of the attribute data 132 may also include using the n-gram generator 134 to generate character n-grams, such as character tri-grams, from the tokens for each attribute (e.g., first-name, last-name, email, address, etc.) In some embodiments, a character tri-gram may be used as an index for pointing to users having attribute data that contain that particular character tri-gram. In some embodiments, ascii characters such as a-z and 0-9 are used for the character tri-gram (e.g., index) and index size may be limited to a size that is less than or equal to a predetermined amount, such as fifty thousand. In some embodiments, each attribute has a separate index, and each user in the network environment may be associated with a unique identifier (e.g., a numerical user ID). In some embodiments, a data store (e.g., a user data store) may be a repository of the indexes provided by the n-grams. Table 1 below shows an example of indexes associated with a data store (containing information about users in the network environment). The column labeled as “count” indicates the number of tri-grams for each type of tri-gram listed in Table 1.

TABLE 1
An example of different types of tri-gram indexes

| Type of tri-gram | Count |
|---|---|
| address_ngrams | 8,654 |
| Business_name_ngrams | 13,454 |
| Email_ngrams | 31,023 |
| First_name_ngram | 5,871 |
| Last_name_ngram | 7,262 |

Table 2 below shows an example of email_ngrams. For example, Table 2 shows five example tri-grams from the list of 31,023 email_ngrams summarized in table 1. The list of unique identifiers indicates which user(s) in the network environment has an email tni-gram corresponding to that tabulated in the left column.

TABLE 2
An example of email n-gram indexes

| N-gram | List of unique identifiers |
|---|---|
| bzv | 34963743 |
| cjb | 32575931 \| 92560241 |
| v87 | 31325423 |
| 31a | 58715309 \| 14869752 |
| tcf | 35567262 |

In addition to preparing the n-gram indexes, weak supervision-based lead generator 136 may also include the candidate set generator 138 to generate a set of candidate users for a single attribute and/or for multiple attributes from the user data store. In some embodiments, the target user may be compared against the set of candidate users to find potential leads or linkages between the target user and one or more other users (e.g., an existing user or previously terminated user) in the network environment. In some embodiments, the candidate set generator 138 receives, as inputs, the target user (e.g., the target user's unique identifier), the type of attribute (e.g., email, name, etc.), a data table associated with the target user, and an upper threshold for a number of unique identifiers.

Using the single attribute case and the attribute type of “email” as an example, the candidate set generator 138 queries the data table associated with the target user using the target user's unique identifier to obtain a tuple that includes the target user's unique identifier and the target user's email. The candidate set generator 138 generates tri-grams for the target user's email (e.g., using the n-gram generator 134). For each tri-gram generated from the target user's email, the candidate set generator 138 queries the user data store (e.g., using the matching n-gram type, such as email_ngrams) to receive a list of unique identifiers of users in the network environment whose email also contain that particular tri-gram. If the number of unique identifiers in the list is less than or equal to the upper threshold for the number of unique identifiers, the list of unique identifiers may be added to the candidate set. Setting an upper threshold helps to filter out common tri-grams that are shared by many users and may not offer much information for anomaly detection.

Using the multiple attribute case and the attribute types of “email and business name” as an example, the candidate set generator 138 queries the data table associated with the target user using the target user's unique identifier to obtain a tuple that includes the target user's unique identifier, the target user's email, and the target user's business name. The candidate set generator 138 generates tri-grams for the target user's email (e.g., using the n-gram generator 134), and also generates tri-grams for the target user's business names (e.g., using the n-gram generator 134). Similar to the example process described above with reference to the case involving a single attribute type of “email,” the candidate set generator 138 queries the user data store, for each tri-gram of the target user's email, to receive a list of unique identifiers of users in the network environment whose email also contain that particular tri-gram. The list of unique identifiers may be added to an email candidate set if the number of unique identifiers in the list is less than or equal to the upper threshold for the number of unique identifiers. For each tri-gram of the target user's business name, the candidate set generator 138 queries the n-grams of the matching n-gram type (e.g., business_name_ngrams in Table 1) in the user data store to receive a list of unique identifiers of users having business names that contain that particular tri-gram. The list of unique identifiers may be added to a business name candidate set if the number of unique identifiers in the list is less than or equal to the upper threshold for the number of unique identifiers. A consolidated candidate list selects unique identifiers that appear in both the email candidate set and the business name candidate set. In some embodiments, the upper threshold for the number of unique identifiers may be set to a few hundred (e.g., less than 900, less than 600, less than 500, less than 300, etc.) for both single attribute candidate lists and multiple attribute candidate lists to avoid tri-grams that are common to many users (e.g., “com”, “123”, “888”, etc.) and may not convey sufficient information.

The similarity score calculator 140 may be used to identify potential leads or fuzzy matches from either the single attribute candidate lists or the multiple attribute candidate lists. For example, the similarity score calculator 140 may calculate a similarity score for one or more attributes between a target user and one or more candidate users based on n-grams generated from one or more attributes. In some embodiments, the similarity score calculator 140 may be used to calculate a degree of similarity (e.g., using cosine similarity) between various tri-grams of the target user and the tri-grams of one or more candidate users from the candidate lists. For each candidate user on the candidate list, attribute data may be retrieved from a data table associated with the candidate user and tri-grams are generated for that attribute (e.g., by the n-gram generator 134), and the similarity score calculator 140 may be used to calculate a degree of similarity (e.g., using cosine similarity) between various tri-grams of the target user and the tri-grams of one or more candidate users from the retrieved attribute data.

A pair of users may, for a given attribute, be associated with a fuzzy-match score based on the output of the similarity score calculator 140. In some embodiments, the fuzzy-match score is between 0 and 1.0. For example, a first user and a second user may have a fuzzy-match score (e.g., strength) of 0.9 based on name. In some embodiments, a degree of similarity is considered sufficiently high when a similarity score meets or exceeds a predetermined threshold, such as a value of at least 0.75, at least 0.8, at least 0.9, etc. For multiple attributes, a score may be computed separately for each attribute, and an average of the scores may be compared against the threshold (e.g., the same similarity threshold as for a single attribute, a different similarity threshold than that for the single attribute, different thresholds for each attribute). For example, the weak supervision-based lead generator 136 determines whether the similarity score between the target user and a first candidate user of the one or more candidate users for a first attribute of the one or more attributes is greater than a first threshold (e.g., greater than a similarity score threshold value of at least 0.75, at least 0.8, or at least 0.9, etc.).

In some embodiments, the weak supervision-based lead generator 136 may provide a candidate user that meets the similarity score threshold as an output, optionally together with the user's similarity score, to generate feedback data 142 (e.g., from human agents). For example, in response to determining that the similarity score between the target user and the first candidate user is greater than the first threshold, the weak supervision-based lead generator 136 may generate link data that links the target user to the first candidate user for the first attribute. For example, with respect to the target user p₁ and a candidate user p₂, the similarity score calculator 140 computes a similarity score of 0.9 based on the “name” attribute, which may meet or exceed a similarity score threshold value. As a result, the weak supervision-based lead generator 136 generates link data that links the target user p₁ and the candidate user p₂ for the “name” attribute and may optionally provide the score of 0.9 in the link data.

In some embodiments, feedback data 142 includes input regarding relevance of the potential fuzzy matching leads. For example, the link data in the example described above (e.g., in a format of “p₁->p₂ (name, score: 0.9)” or any other suitable format) may be received and feedback data 142 may be provided on whether any action has been or will be taken (e.g., termination, suspension, increased monitoring, no action is to be taken) on the target user p₁ based on the candidate user p₂. For example, the candidate user p₂ may be a previously terminated user, and the feedback (e.g., based on additional investigations or additional data from one or more sources) may indicate that the target user p₁ is linked to the candidate user p₂, that the target user p₁ has manipulated the name attribute in an attempt to circumvent system safeguards in the network environment, and/or that the candidate user p₂ is in fact attempting to masquerade as the target user p₁. In some embodiments, feedback data 142 may constitute either positive feedback or negative feedback depending on one or more actions taken. If a user identified by the weak supervision-based lead generator 136 is terminated or suspended, the data associated with that user may be considered a positive example for the training data. If no action is taken on a user identified by the weak supervision-based lead generator 136, the data associated with that user may be considered a negative example for the training data. Any target user that may be connected to any previously terminated or suspended user via any attribute may be considered risky and may be incorporated as positive examples in the training data. Additionally pairs of users with low scores (e.g., computed by the similarity score calculator 140) or other random examples with low similarity scores are added to the training data as negative examples. The training data is balanced and includes data from most (e.g., all) attributes like name, email, business-name and address to train the model.

The feedback data 142 and/or the output of potential fuzzy matching leads (e.g., link data) from the weak supervision-based lead generator 136 may be provided, as training data, to a deep learning model trainer 144 that applies a model training process to generate a model output. For example, in some embodiments, the deep learning model trainer 144 may apply an iterative model training process to generate a model output representative of a deep neural network. The trained deep learning model (e.g., the model output) learns representations of similar or semantically similar attributes between users, and scores the potential fuzzy matching leads (e.g., optionally output from the weak supervision-based lead generator 136) to generate a prediction of a match between the target user and one of more users of the network environment. For example, training the machine learning model using the link data may include learning, using a deep learning model, representations from the fuzzy-matched leads.

The outputs of the deep learning model may be provided to a machine learning model to learn weights or importance of the attributes via an anomaly score weight determinator 146. Based on the weights determined by the anomaly score weight determinator 146, an anomaly score calculator 148 calculates an anomaly score of the target user. For example, the anomaly detector 130 trains a machine learning model (e.g., a deep learning model) using the link data. The machine learning model identifies a likelihood whether the target user is linked to a terminated entity based on the one or more attributes (e.g., via a score computed by the anomaly score calculator 148). The machine learning model applies respective weights to each of the one or more attributes (e.g., via the anomaly score weight determinator 146). The term “terminated entity” as used herein is used interchangeably with the term “terminated user,” or “previously terminated user.” For example, the respective weights associated with the one or more attributes are determined by directing outputs of the deep learning model to the machine learning model to update at least one weight of the respective weights of at least one of the one or more attributes.

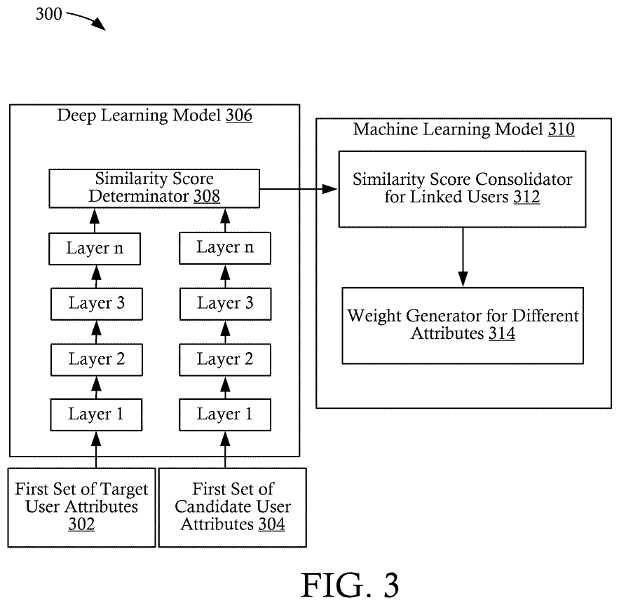

In some embodiments, a model-based approach to identify linkages between a target user and previously terminated or suspended users may take into account synonyms or semantically similar text and may provide more accurate fuzzy-matches compared to the weak supervision-based lead generator 136. More details about the deep learning model and the machine learning model used by the anomaly score weight determinator 146 and/or the anomaly score calculator 148 is provided in FIG. 3. For example, a deep learning-based approach may perform better than the weak supervision-based lead generator 136 for identifying a linkage between manipulated email addresses “admin101@emaildomain.me” and “admin1345678@emaildomain.me”. For the weak supervision-based lead generator 136, the similarity score (e.g., calculated by the similarity score calculator 140) may be based on character trigrams, and may return a similarity score that is less than the high similarity threshold (due to the lower number of matching trigrams between the two manipulated email addresses). In contrast, the deep learning-based approach may be better able to compute the similarity between the representations of the two manipulated emails and would give the two manipulated emails a score that is greater than the high similarity threshold.

Different attributes may contribute differently to the outcome of user-riskiness assessment (e.g., reflected in a score generated by the anomaly score calculator 148). For initial runs of the machine learning model in the anomaly detector 130, weights may be initialized at initial values. Feedback that identifies various reasons for terminating, suspending or taking no action on a respective user based on the different attributes may be incorporated into the anomaly detection system. In some embodiments, a logistic regression model (or any other machine-learning model) is used to generate entity riskiness, and the weights for the different attributes are initialized according to the model. In some embodiments, the weights are adjusted upwards or downwards depending on feedback (e.g., provided to the anomaly score weight determinator 146 and/or the anomaly score calculator 148), optionally, on a regular basis.

In some embodiments, a first weight update method includes determining the number of cases actioned upon by in a preceding time period (e.g., week (t−2) and week (t−1)) due to a particular attribute. For example, nₜ₋₁ may be the number of cases associated with a given attribute in week (t−1) and nₜ₋₂ may be the number of cases associated with the given attribute for week (t−2), and wₜ₋₁ and wₜ₋₂ may be the weights for week (t−1) and for week (t−2) for the given attribute, respectively. For simplicity, N cases may be reviewed each week. The weight wₜ for the given attribute e for week t is:

$${w}_{t} = {w}_{t - 1} ( 1 + \frac{{n}_{t - 1} - {n}_{t - 2}}{N} ) .$$

For example, the anomaly detector 102 may update the respective weights associated with the one or more attributes (e.g., via the anomaly score weight determinator 146) based on feedback data 142 associated with changes in operating permissions within a predetermined time period. The feedback data 142 may include numbers of users identified based on respective attributes of the one or more attributes in a preceding time period (e.g., in week (t−1), in week (t−2), etc.) In some embodiments, users are reviewed (e.g., onboarding of users) on a weekly basis and the updates to the weights of the various attributes may help ensure that the anomaly detection system is responsive to trends (e.g., emerging trends) captured by recent actions. In some embodiments, weight updates take into consideration feedback from a preceding time period (e.g., past two weeks, past three weeks, past month, past two months).

In some embodiments, in response to a determination based on the updated respective weights that the likelihood of the target user being linked to the terminated entity exceeds a second threshold indicating that an anomaly has been detected, the anomaly detection computer device 102 modifies or sends control signals to modify one or more operating permissions associated with the target user within a network environment. For example, the operating permissions associated with the target user may include operating permissions that permit the target user to log into the network environment and perform one or more operations including: listing an item for sale, removing a listing, checking inventory status, leaving feedback, receiving payment, changing payment information and/or issuing refunds, within the network environment. In some embodiments, modifying the operating permissions includes terminating a user's ability to log into the network environment and perform operations within the network environment. In some embodiments, modifying the operating permissions includes suspending, for a set period of time, a user's ability to log into the network environment and perform operations within the network environment.

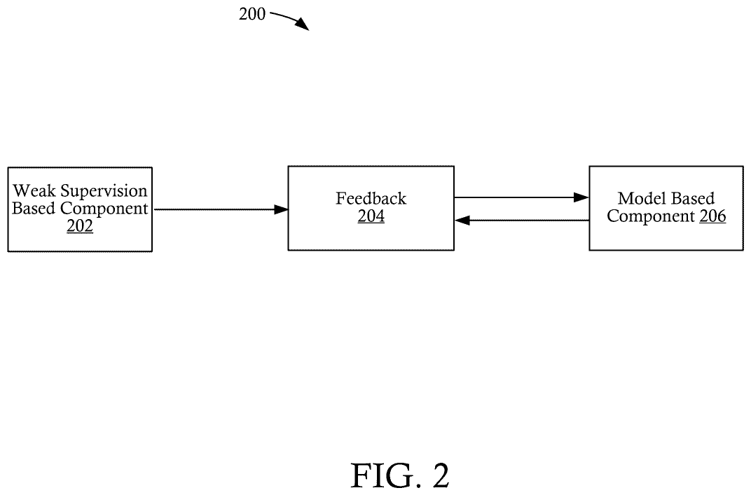

FIG. 2 is a schematic diagram of how feedback may be used within an example anomaly detection system in accordance with some embodiments. The system 200 may be implemented by a computing device, such as the anomaly detection computing device 102 illustrated in FIG. 1. The system 200 implements an anomaly detection process that determines the likelihood of a target user being linked to one or more previously terminated or suspended users. The system 200 includes a weak supervision-based component 202 that generates leads of potential linkage between the target user and one or more other users in the network environment. In some embodiments, the weak supervision-based component 202 may be implemented by the weak supervision-based lead generator 136 illustrated in FIG. 1. The system 200 includes feedback 204 that is provided based on evaluation of the output from the weak supervision-based component 202. The feedback 204 regarding the output from the weak supervision-based component 202 is relayed to a model-based component 206, for example, to generate training data for a machine learning model, such as a deep learning model. The model-based component 206 may be implemented by the deep learning model trainer 144, the anomaly score weight determinator 146, and the anomaly score calculator 148 illustrated in FIG. 1, and/or the machine learning models illustrated below with reference to FIG. 3. Output from the model-based component 206 may be sent for further review and generation of additional feedback 204 to fine-tune the performance of the model-based component 206 (e.g., by adjustments of weights based on feedback data 142 that is provided to the anomaly score weight determinator 146 and/or the anomaly score calculator 148, as illustrated in FIG. 1).

Any deep learning architecture may be adopted to identify linkages between the target user and previously terminated or suspended users in the network environment. In some embodiments, a Deep Neural Network model, such as a Deep Semantic Similarity model (DSSM) is used. FIG. 3 is a block diagram of example machine learning models used in an example anomaly detection system in accordance with some embodiments. A system 300 includes a deep learning model 306 and a machine learning model 310. The system 300 may be implemented by a computing device, such as the anomaly detection computing device 102 (e.g., by one or more of the deep learning model trainer 144, anomaly score weight determinator 146, and/or the anomaly score calculator) illustrated in FIG. 1.

The deep learning model 306 receives, as input, a first set of target user attributes 302 (e.g., optionally derived from attribute data 132 in FIG. 1), and a first set of candidate user attributes 304 (e.g., optionally derived from attribute data 132 in FIG. 1), for example, generated by the candidate set generator 138. As in the weak supervision-based lead generator 136, the first set of target user attributes 302 and first set of candidate user attributes 304 may be preprocessed (e.g., cleaned) prior to being provided to the deep learning model 306. In some embodiments, the first set of target user attributes 302 includes potential leads generated by the weak supervision-based lead generator 136.

In some embodiments, bag of character tri-gram hashing may be used on the first set of target user attributes 302 and the first set of candidate user attributes 304 to generate respective term vectors (e.g., “Layer 1”), each of a size of about five hundred thousand, sufficient to represent most English words. The term vector is passed through n-layers of fully connected layers. In some embodiments, the n-layers include three fully connected layers of sizes: thirty thousand (e.g., “Layer 2”), three hundred (e.g., “Layer 3”), and 128 (“Layer n”). The final layer (“Layer n”) generates embeddings of the first set of target user attributes 302 and the first set of candidate user attributes 304. For example, the deep learning model 306 may generate a first embedding of a first attribute from the first set of target user attributes 302. The deep learning model may also generate a second embedding of a first attribute from the first set of candidate user attributes 304. A similarity score determinator 308 calculates a degree of similarity (e.g., using cosine similarity) between the embeddings of the first set of target user attributes 302 and the first set of candidate user attributes 304. For example, the similarity score determinator 308 determines a similarity (e.g., a cosine similarity) between the first embedding and the second embedding.

The output of the similarity score determinator 308 is used to learn whether the first set of target candidate attributes 304 is fuzzy matched to the first set of target user attributes 302. In some embodiments, cross entropy loss is used as a loss function for the deep learning model 306. In some embodiments, the deep learning model 306 is trained offline to learn representations from the leads (e.g., obtained from the weak supervision-based lead generator 136) provided as input to the deep learning model 306. For example, training the machine learning model using the link data includes learning, using the deep learning model 306, representations from the fuzzy-matched leads. In some embodiments, tanh is used as activation at an output layer and a hidden layer of the deep learning model 306.

In some embodiments, inference is performed when a query about a target user is received (e.g., to compute a riskiness score, or an anomaly score associated with the target user). During inference, embeddings for various attributes of the target user may be generated, and cosine similarity may be calculated. Score threshold values may be defined and used for generating a riskiness score or anomaly score. The deep learning model 306 and/or the machine learning model 310 include weights, layer definitions, and/or other data that allows implementation of the anomaly detector 130 for real-time inferencing.

The outputs of the deep learning model 306 are fed to a machine learning model 310 to learn the underlying characteristics or patterns of the attributes and to generate a weight (e.g., level of riskiness) for each attribute. In some embodiments, a total of about twenty attributes are used for fuzzy matching. Some attributes among the twenty attributes may be riskier than others. For example, two users may have warehouses at the street number and street name in the same city but have different suite numbers and they are not connected by any other attributes and may be considered a less risky example. In contrast, two users having similar business names may suggest a potential risk of one user (e.g., or business) impersonating the other user or business.

As an example, the first set of target user attributes 302 that includes a set of n attributes of the target user p₁ and the first set of candidate user attributes 304 that includes a set of n attributes of the candidate user p₂ are provided as input to the deep learning model 306. An example of the learned representations is an array of linkage probability Sₚ₁ₚ₂ among the n attributes between the target user p₁ and the candidate user p₂: Sₚ₁ₚ₂=[s₁₂, s₂₂, . . . , sₙ₂], where sₙ₂ stands for the linkage probability (e.g., calculated by the similarity score determinator 308) from the target user p₁ to the candidate user p₂ based on the n-th attribute.

Sₚ₁ₚₘ represents a linkage probability vector between target user p₁ and user pₘ across n entities and may be expressed as:

$${S}_{p 1 p 2} = [ {s}_{12} , {s}_{22} , … , {s}_{n 2} ] ;$$

$${S}_{p 1 p 3} = [ {s}_{13} , {s}_{23} , … , {s}_{n 3} ] ;$$

$${S}_{p 1 p 4} = [ {s}_{14} , {s}_{24} , … , {s}_{n 4} ] ;$$

$${S}_{p 1 pm} = [ {s}_{1 m} , {s}_{2 m} , … , {s}_{n m} ]$$

where sⱼₘ represents a linkage probability from the target user p₁ to a user pₘ based on attribute j. As there are n attributes, j varies from 1 to n in sⱼₘ. For the target user p₁, a similarity score consolidator 312 sums the scores for each attribute across the m users with whom the target user p₁ has fuzzy-matched.

$${S}_{p 1} = [ \sum {s}_{1 k} , \sum {s}_{2 k} … , \sum {s}_{n k} ] , k = 2 , … m .$$

The similarity score consolidator 312 for linked users collects the scores for all the users that have had an action in the last few months. Actions like termination or suspension may lead to a label of +1 and no action may lead to a label of 0. Each of the n attributes may have a weight. In some embodiments, the similarity score consolidator 312 may feed the scores to a machine learning model (e.g., a logistic regression model or other machine learning model) in a weight generator 314 for different attributes to obtain or learn the importance of the attribute weights. For example, the weight generator 314 may output a weight vector w=[w₁, w₂, . . . , wₙ] that represents the importance of the n attributes. The machine learning model 310 may be refreshed periodically to ensure accuracy of the attribute weights (e.g., based on the feedback 204 provided to the model-based component 206 as illustrated in FIG. 2).

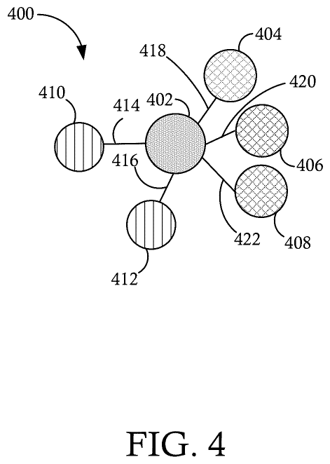

FIG. 4 is a block diagram showing example linkages of a target user in accordance with some embodiments. A linkage network 400 includes a target user p₁, denoted as a node 402, that is connected to m users p₂, p₃, . . . pₘ(e.g., represented as nodes 404, 406, 408, 410 and 412). A first approach to determining a riskiness score is based on the number of connections of the target user p₁ to previously terminated or suspended users. For example, nodes 404, 406 and 408 may be previously terminated users while nodes 410 and 412 are users with no negative history. A riskiness score R of the target user p₁ may be calculated as: R=m₁/m. In this first approach, linkage 414 is not differentiated from any of the other linkages 416, 418, 420 and 422 (e.g., counted equally in the determination of R, depending on whether the linkage is to a previously terminated or suspended user).

A second approach for determining a riskiness score is based on summing scores for each of the n attributes across all users that are connected to the target user p₁. For example, user p₁ is connected to five users p₂, p₃, . . . p₆, represented as nodes 404, 406, 408, 410 and 412 in FIG. 4. In some embodiments, the similarity score consolidator 312 may sum the scores (e.g., obtained from the similarity score determinator 308) for each attribute across all users that are connected to the target user p₁. The similarity score consolidator 312 generates, as an output, a vector of scores for the n attributes:

Sₚ₁=[Σs₁ₖ, Σs₂ₖ . . . , Σsₙₖ], where k=2 . . . 6. The vector of scores is collected for many users and then a machine learning model is trained to learn the weights of the attributes. The weight generator 314 for different attributes outputs a weight vector, w=[w₁, w₂, . . . , wₙ] representing the importance of the attributes. Due to different weights being assigned to different attributes that links different users to the target user, linkage 414 are differentiated from the other linkages 416, 418, 420 and 422 (e.g., counted by a weighted amount in the determination of a riskiness/anomaly score).

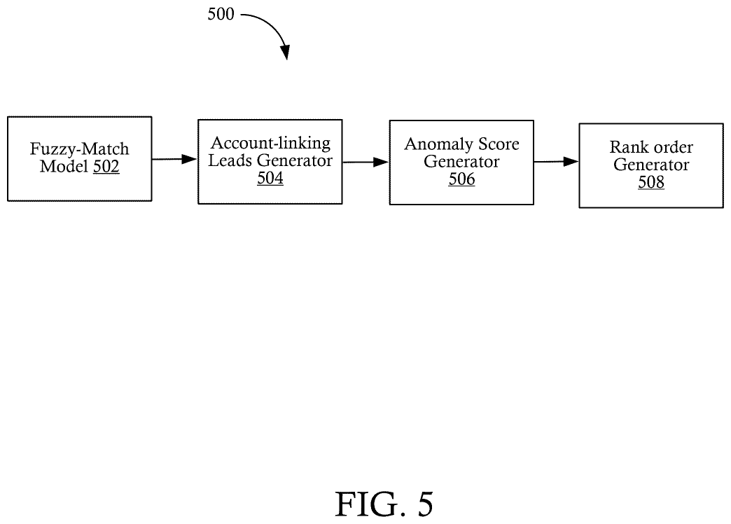

FIG. 5 is a schematic diagram of different components in an anomaly detection system in accordance with some embodiments. An anomaly detection system 500 includes a fuzzy-match model 502 that receives, as input, attribute data (e.g., attribute date 132) from a target user and unique identifiers associated with the target user. The system 500 may be implemented by a computing device, such as the anomaly detection computing device 102 illustrated in FIG. 1. The fuzzy-match model 502 provides input to an account-linking leads generator 504. The fuzzy-match model 502 may be implemented as the weak supervision-based lead generator 136 illustrated in FIG. 1 and the account-linking leads generator 504 may be implemented by the same weak supervision-based lead generator 136 and/or the machine learning models described in system 300 illustrated in FIG. 3. An anomaly score generator 506 generates an anomaly score based on input received input from the account-linking leads generator 504. The anomaly score generator 506 may be implemented as the anomaly score weight determinator 146 and/or the anomaly score generator 148 illustrated in FIG. 1, and/or the similarity score consolidator 312 for linked users and/or the weight generator 314 for different attributes 314 illustrated in FIG. 3. A list of anomaly scores may be provided to a rank order generator 508 to rank order users for human agents to review.

In some embodiments, the account-linking leads generator 504 may generate leads by providing a similarity score between two users for a particular attribute. For example, with respect to target user p₁ and a user p₂, a similarity score of 0.9 may be calculated (e.g., based on the similarity score calculator 140, based on the similarity score determinator 308, etc.) based on the “name” attribute. With respect to target user p₁ and a user p₃, a similarity score of 0.99 may be calculated for the “address” attribute. With respect to the target user p₁ and a user p₅, a similarity score of 0.99 may be calculated for the “email” attribute. With respect to the target user p₁ and a client user ci, a similarity score of 0.97 may be calculated for the “second email” attribute. Separately, with respect to the user p₂ and the target user p₁, a similarity score of 0.9 may be calculated for the “name” attribute (e.g., identical to the similarity score for the “name” attribution from the target user p₁ to the user p₂). With respect to the user p₂ and a user p₆, a similarity score of 0.99 may be calculated for the “address” attribute. With respect to the user p₂ and a user p₇, a similarity score of 0.96 may be calculated for the “email” attribute. In some embodiments, an overall riskiness score of a target user is obtained by combining the output from the fuzzy-match process (e.g., generated by the weak supervision-based lead generator 136 and/or the deep learning model 306) and the weights of entities (e.g., determined by the weight generator 314 for different attributes).

The anomaly score generator 506 may compute an overall riskiness score (e.g., a universal user riskiness score) that is then used by the rank order generator 508 to rank users for risk adjudication by human agents. A target user p₁ may be connected to several other users p₂, p₃, . . . pₘ. Let sⱼ be the score obtained after taking the similarity score for attribute eⱼ between the pair of the target user p₁ and the user p₂. For n attributes, j in eⱼ may vary from 1 to n. Weighted average score for the pair of users p₁ and p₂ is Sₚ₁ₚ₂=(s₁*w₁+s₂*w₂+ . . . sₙ*wₙ)/(w₁+w₂+ . . . +wₙ). In some embodiments, the anomaly score generator 506 computes a score for every pair of users p₁, pᵢ, where i=2, . . . m that the target user p₁ is linked to.

Using the example similarity scores described above, the anomaly score generator 506 may compute the riskiness score for target user p₁ as p_{1_rs}=(0.9*w₁+0.99*w₂+0.96*w₃+0.97*w₄)/(w₁+w₂+w₃+w₄), where 0.9, 0.99, 0.96, and 0.97 are the similarity scores (e.g., obtained from the account-linking leads generator 504) for the name, address, email, and second email attributes, respectively, and w₁, w₂, w₃, w₄ are the weights for the name, address, email, and second email attributes, respectively. In some embodiments, the weights (e.g., w₁, w₂, . . . wₙ) are learned from a logistic regression model (e.g., in the machine learning model 310). The riskiness score for user p₂ may be calculated as p_{2_rs}=(0.9*w₁+0.99*w₂+0.96*w₃)/(w₁+w₂+w₃), where 0.9, 0.99, and 0.96 are the similarity scores for the name, address, and email attributes, respectively, and w₁, w₂, and w₃ are the weights for the name, address, and email attributes, respectively. In some embodiments, the weights for different attributes are the same across different users (e.g., a weight w₂ of 0.99 is used for the “address” attribute, both for the pair of users p₁ and p₃, and for the pair of users p₂ and p₆).

In some embodiments, the anomaly score generator 506 calculates a universal total linkage score U for the target user p₁,

$$U = {\sum }_{i = 1}^{m} {S}_{p 1 pi} .$$

In some embodiments, the anomaly score generator 506 calculates a universal average linkage score A for the target user p₁:

$$A = \frac{1}{m} {\sum }_{i = 1}^{m} {S}_{p 1 pi} .$$

Either the universal total linkage score U or the universal average linkage score A may be used to rank order cases to be adjudicated by agents.

In some embodiments, the anomaly detection systems and methods described herein may be used for user lifecycle risk adjudication, in addition to being used for user onboarding. For example, the anomaly detection method may be used in near real time or be part of a regular administrative process (e.g., weekly, biweekly auditing or checking).

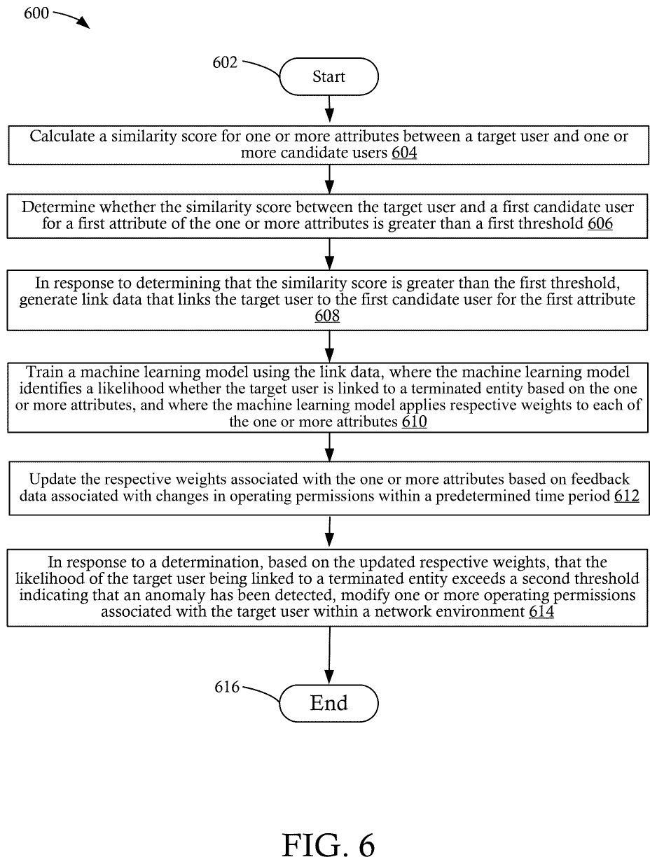

FIG. 6 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 6 may be implemented in the form of executable instructions stored on machine-readable media and executed by a processing resource and/or in the form of electronic circuitry. For example, aspects of the methods may be described below as being performed by an anomaly detection system, an example of which may be the anomaly detection process 600 running on a hardware processing resource 104 of the anomaly detection computing device 102 described above. Additionally, other aspects of the methods described below may be described with reference to other elements shown in FIG. 1 for non-limiting illustration purposes.

FIG. 6 depicts a flow diagram illustrating a method 600 of anomaly detection, in accordance with some embodiments. Method 600 starts at block 602 and continues to block 604, where a similarity score for one or more attributes between a target user and one or more candidate users may be calculated. At block 606, whether the similarity score between the target user and a first candidate user for a first attribute of the one or more attributes is greater than a first threshold may be determined.

At block 608, in response to determining that the similarity score is greater than the first threshold, link data that links the target user to the first candidate user for the first attribute is generated.

At block 610, a machine learning model using the link data may be trained, where the machine learning model identifies a likelihood whether the target user may be linked to a terminated entity based on the one or more attributes, and where the machine learning model applies respective weights to each of the one or more attributes.

At block 612, the respective weights associated with the one or more attributes based on feedback data associated with changes in operating permissions within a predetermined time period may be updated.

At block 614, in response to a determination, based on the updated respective weights, that the likelihood of the target user being linked to a terminated entity exceeds a second threshold indicating that an anomaly has been detected, one or more operating permissions associated with the target user within a network environment are modified. At block 616, the method 600 ends.

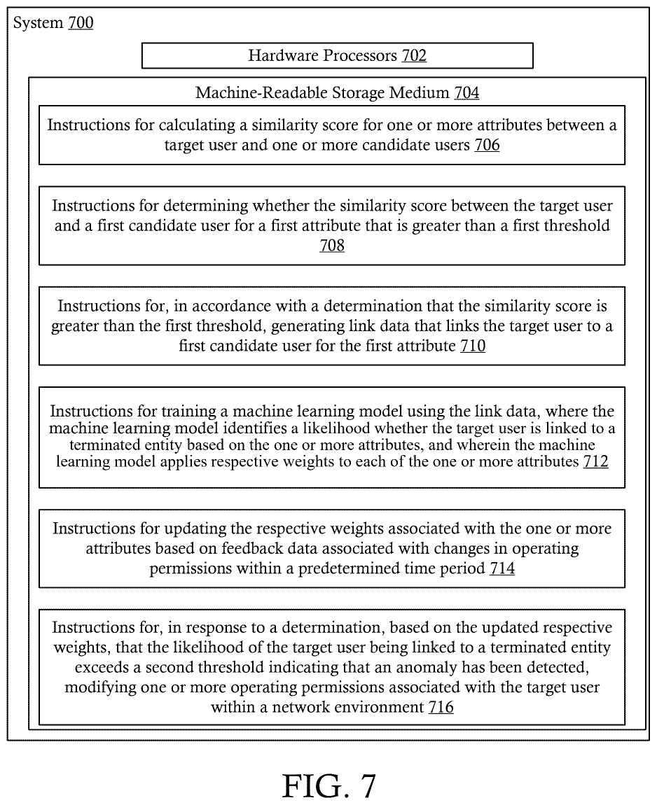

FIG. 7 depicts an example system 700 that includes non-transitory, machine-readable media 704 encoded with example instructions executable by processing resource 702. In some implementations, the system 700 may be useful for implementing aspects of the anomaly detector 130 of FIG. 1. For example, the instructions encoded on machine-readable media 704 may be included in instructions 108 of FIG. 1. In some implementations, functionality described with respect to FIG. 1 may be included in the instructions encoded on machine-readable media 704.

The processing resource 702 may include a microcontroller, a microprocessor, central processing unit core(s), an ASIC, an FPGA, and/or other hardware device suitable for retrieval and/or execution of instructions from the machine-readable media 704 to perform functions related to various examples. Additionally, or alternatively, the processing resource 702 may include or be coupled to electronic circuitry or dedicated logic for performing some or all of the functionality of the instructions described herein.

The machine-readable media 704 may be any medium suitable for storing executable instructions, such as RAM, ROM, EEPROM, flash memory, a hard disk drive, an optical disc, or the like. In some example implementations, the machine-readable media 704 may be a tangible, non-transitory medium. The machine-readable media 704 may be disposed within the system 700 respectively, in which case the executable instructions may be deemed installed or embedded on the system. Alternatively, the machine-readable media 704 may be a portable (e.g., external) storage medium, and may be part of an installation package.

As described further herein below, the machine-readable media 704 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 7.

With reference to FIG. 7, the machine-readable media 704 includes instructions 706-716. Instructions 706, when executed, cause the processing resource 702 to calculate a similarity score for one or more attributes between a target user and one or more candidate users. Instructions 708, when executed, cause the processing resource 702 to determine whether the similarity score between the target user and a first candidate user for a first attribute that may be greater than a first threshold.

In accordance with a determination that the similarity score is greater than the first threshold, instructions 710, when executed, cause the processing resource 702 to generate link data that links the target user to a first candidate user for the first attribute.

Instructions 712, when executed, cause the processing resource 702 to train a machine learning model using the link data, where the machine learning model identifies a likelihood whether the target user is linked to a terminated entity based on the one or more attributes, and wherein the machine learning model applies respective weights to each of the one or more attributes.

Instructions 714, when executed, cause the processing resource 702 to update the respective weights associated with the one or more attributes based on feedback data associated with changes in operating permissions within a predetermined time period. In response to a determination, based on the updated respective weights, that the likelihood of the target user being linked to a terminated entity exceeds a second threshold indicating that an anomaly has been detected, instructions 716, when executed, cause the processing resource 702 to modify one or more operating permissions associated with the target user within a network environment.

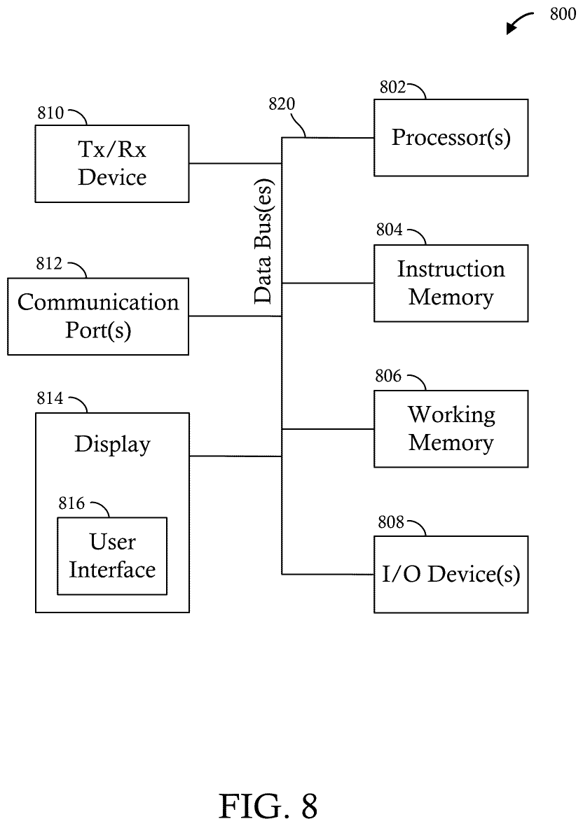

FIG. 8 illustrates a block diagram of a computing device 800, in accordance with some embodiments. Although FIG. 8 is described with respect to certain components shown therein, it will be appreciated that the elements of the computing device 800 may be combined, omitted, and/or replicated. In addition, it will be appreciated that additional elements other than those illustrated in FIG. 8 may be added to the computing device.

As shown in FIG. 8, the computing device 800 may include one or more processing resources 802, instruction memory 804, working memory 806, input/output devices 808, transceiver 810, communication ports 812, display 814, optional location device 818, and/or any other suitable elements each operatively coupled to one or more data buses 820. The data buses 820 allow for communication among the various components. The data buses 820 may include wired, or wireless, communication channels.

The one or more processing resources 802 may include any processing circuitry operable to control operations of the computing device 800. In some embodiments, the one or more processing resources 802 include one or more distinct processors, each having one or more cores (e.g., processing circuits). Each of the distinct processors may have the same or different structure. The one or more processing resources 802 may include one or more central processing units (CPUs), one or more graphics processing units (GPUs), ASICs, digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 802 may also be implemented by a controller, a microcontroller, an ASIC, an FPGA, a programmable logic device (PLD), etc.

In some embodiments, the one or more processing resources 802 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 804 may store instructions that are accessed (e.g., read) and executed by at least one of the one or more processing resources 802. For example, the instruction memory 804 may be a non-transitory, computer-readable storage medium such as a ROM, an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 802 may perform a certain function or operation by executing code, stored on the instruction memory 804, embodying the function or operation. For example, one or more processing resources 802 may execute code stored in the instruction memory 804 to perform one or more of any function, method, or operation disclosed herein.

Additionally, the one or more processing resources 802 may store data to, and read data from, the working memory 806. For example, one or more processing resources 802 may store a working set of instructions to the working memory 806, such as instructions loaded from the instruction memory 804. The one or more processing resources 802 may also use the working memory 806 to store dynamic data created during one or more operations. The working memory 806 may include, for example, RAM such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), CAM, polymer memory (e.g., ferroelectric polymer memory), phase-change memory (e.g., ovonic memory), ferroelectric memory, SONOS memory, a removable disk, CD-ROM, any non-volatile memory, or any other suitable memory. Although embodiments are illustrated herein including separate instruction memory 804 and working memory 806, it will be appreciated that the computing device 800 may include a single memory unit that operates as both instruction memory and working memory. Further, although embodiments are discussed herein including non-volatile memory, it will be appreciated that computing device 800 may include volatile memory components in addition to at least one non-volatile memory component.

In some embodiments, the instruction memory 804 and/or the working memory 806 includes an instruction set, in the form of a file for executing various methods, such as methods for generating an interface based on location data and resource use probability, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 802.

The input/output devices 808 may include any suitable device that allows for data input or output. For example, the input/output devices 808 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 810 and/or the communication port(s) 812 allow for communication with a network. For example, if a communication network is a cellular network, the transceiver 810 allows communications with the cellular network. In some embodiments, the transceiver 810 is selected based on the type of the communication network the computing device 800 will be operating in. The one or more processing resources 802 are operable to receive data from, or send data to, a network, via the transceiver 810.

The communication port(s) 812 may include any suitable hardware, software, and/or combination of hardware and software that is capable of coupling the computing device 800 to one or more networks and/or additional devices. The communication port(s) 812 may be arranged to operate with any suitable technique for controlling information signals using a desired set of communications protocols, services, or operating procedures. The communication port(s) 812 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 812 allows for the programming of executable instructions in instruction memory 804. In some embodiments, the communication port(s) 812 allow(s) for the transfer (e.g., uploading or downloading) of data, such as machine learning model training data.

In some embodiments, the communication port(s) 812 couples the computing device 800 to a network. The network may include local area networks (LAN) as well as wide area networks (WAN) including without limitation internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 810 and/or the communication port(s) 812 utilize one or more communication protocols. Examples of wired protocols may include, but are not limited to, USB communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 814 may be any suitable display and may display the user interface 816. The user interface 816 may enable user interaction with interface elements representative of an anomaly detector 130. For example, the user interface 816 may be a user interface for an application of a network environment operator that allows a user to view and interact with the operator's website. In some embodiments, a user may interact with the user interface 816 by engaging the input/output devices 808. In some embodiments, the display 814 may be a touchscreen, where the user interface 816 is displayed on the touchscreen.

The display 814 may include a screen such as, for example, a Liquid Crystal Display (LCD) screen, a light-emitting diode (LED) screen, an organic LED (OLED) screen, a movable display, a projection, etc. In some embodiments, the display 814 may include a coder/decoder, also known as Codecs, to convert digital media data into analog signals. For example, the visual peripheral output device may include video Codecs, audio Codecs, or any other suitable type of Codec.

The optional location device 818 may be communicatively coupled to a location network and operable to receive position data from the location network. For example, in some embodiments, the location device 818 includes a GPS device that receives position data identifying a latitude and longitude from one or more satellites of a GPS constellation. As another example, in some embodiments, the location device 818 is a cellular device that receives location data from one or more localized cellular towers. Based on the position data, the computing device 800 may determine a local geographical area (e.g., town, city, state) of its position.

In some embodiments, the computing device 800 implements one or more modules or engines, each of which is constructed, programmed, configured, or otherwise adapted, to autonomously carry out a function or set of functions. A module/engine may include a component or arrangement of components implemented using hardware, such as by an ASIC or FPGA, for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that execute an operating system, system programs, and application programs, while also implementing the engine using multitasking, multithreading, distributed (e.g., cluster, peer-peer, cloud) processing where appropriate, or other such techniques. Accordingly, each module/engine may be realized in a variety of physically realizable configurations and should generally not be limited to any particular example implementation herein, unless such limitations are expressly called out. In addition, a module/engine may itself be composed of more than one sub-module or sub-engine, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 800 may be a computer, a workstation, a laptop, a server such as a cloud-based server, or any other suitable device. In some embodiments, the computing device 800 is a server that includes one or more processing units, such as one or more GPUs, one or more CPUs, and/or one or more processing cores. The computing device 800 may, in some embodiments, execute one or more virtual machines. In some embodiments, processing resources (e.g., capabilities) of the computing device 800 are offered as a cloud-based service (e.g., cloud computing).

Although embodiments are illustrated herein including certain systems and/or devices, it will be appreciated that additional systems, servers, storage mechanisms, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
calculate a similarity score for one or more attributes between a target user and one or more candidate users based on n-grams generated from the one or more attributes;
determine whether the similarity score between the target user and a first candidate user of the one or more candidate users for a first attribute of the one or more attributes is greater than a first threshold;
in response to determining that the similarity score between the target user and the first candidate user is greater than the first threshold, generate link data that links the target user to the first candidate user for the first attribute;
train a machine learning model using the link data, wherein the machine learning model identifies a likelihood whether the target user is linked to a terminated entity based on the one or more attributes, and wherein the machine learning model applies respective weights to each of the one or more attributes;
update the respective weights associated with the one or more attributes based on feedback data associated with changes in operating permissions within a predetermined time period; and
in response to a determination, based on the updated respective weights, that the likelihood of the target user being linked to the terminated entity exceeds a second threshold indicating that an anomaly has been detected, modify one or more operating permissions associated with the target user within a network environment.

2. The system of claim 1, wherein the machine learning model:
generates a first embedding of a first attribute of the one or more attributes of the target user;
generates a second embedding of the first attribute of the one or more attributes of the one or more candidate users; and
determines a similarity between the first embedding and the second embedding.

3. The system of claim 1, wherein the one or more attributes comprises one or more unique identifiers of the target user.

4. The system of claim 3, wherein the n-grams identify fuzzy-matched leads between the one or more attributes of the target user and the one or more candidate users.

5. The system of claim 4, wherein training the machine learning model using the link data comprises learning, using a deep learning model, representations from the fuzzy-matched leads.

6. The system of claim 5, wherein the respective weights associated with the one or more attributes are determined by directing outputs of the deep learning model to the machine learning model to update at least one weight of the respective weights of at least one of the one or more attributes.

7. The system of claim 1, wherein the feedback data comprises numbers of users identified based on respective attributes of the one or more attributes in a preceding time period.

8. The system of claim 1, wherein the machine learning model comprises a first deep learning machine model and a second machine learning model, which is trained to learn the respective weights of the one or more attributes from outputs of the first deep learning model, and the second machine learning model applies the respective weights to each of the one or more attributes.

9. A computer-implemented method, comprising:
calculating a similarity score for one or more attributes between a target user and one or more candidate users based on n-grams generated from the one or more attributes;
determining whether the similarity score between the target user and a first candidate user of the one or more candidate users for a first attribute of the one or more attributes is greater than a first threshold;
in response to determining that the similarity score between the target user and the first candidate user for the first attribute is greater than the first threshold, generating link data that links the target user to the first candidate user for the first attribute;
training a machine learning model using the link data, wherein the machine learning model identifies a likelihood whether the target user is linked to a terminated entity based on the one or more attributes, and wherein the machine learning model applies respective weights to each of the one or more attributes;
updating the respective weights associated with the one or more attributes based on feedback data associated with changes in operating permissions within a predetermined time period; and
in response to a determination, based on the updated respective weights, that a likelihood of the target user being linked to the terminated entity exceeds a second threshold indicating that an anomaly has been detected, modifying one or more operating permissions associated with the target user within a network environment.

10. The computer-implemented method of claim 9, wherein the machine learning model:
generates a first embedding of a first attribute of the one or more attributes of the target user;
generates a second embedding of the first attribute of the one or more attributes of the one or more candidate users; and
determines a similarity between the first embedding and the second embedding.

11. The computer-implemented method of claim 9, wherein the one or more attributes comprises one or more unique identifiers of the target user.

12. The computer-implemented method of claim 11, wherein the n-grams identify fuzzy-matched leads between the one or more attributes of the target user and the one or more candidate users.

13. The computer-implemented method of claim 12, wherein training the machine learning model using the link data comprises learning, using a deep learning model, representations from the fuzzy-matched leads.

14. The computer-implemented method of claim 13, wherein the respective weights associated with the one or more attributes are determined by directing outputs of the deep learning model to the machine learning model to update at least one weight of the respective weights of at least one of the one or more attributes.

15. The computer-implemented method of claim 9, wherein the feedback data comprises numbers of users identified based on respective attributes of the one or more attributes in a preceding time period.

16. The computer-implemented method of claim 9, wherein the machine learning model comprises a first deep learning machine model and a second machine learning model, which is trained to learn the respective weights of the one or more attributes from outputs of the first deep learning model, and the second machine learning model applies the respective weights to each of the one or more attributes.

17. A non-transitory computer readable medium having instructions stored thereon, wherein the instructions, when executed by at least one processor, cause at least one device to perform operations comprising:
calculating a similarity score for one or more attributes between a target user and one or more candidate users based on n-grams generated from the one or more attributes;
determining whether the similarity score between the target user and a first candidate user of the one or more candidate users for a first attribute of the one or more attributes is greater than a first threshold;
in response to determining that the similarity score between the target user and the first candidate user for the first attribute is greater than the first threshold, generating link data that links the target user to the first candidate user with respect to the first attribute;
training a machine learning model using the link data, wherein the machine learning model identifies a likelihood whether the target user is linked to a terminated entity based on the one or more attributes, and wherein the machine learning model applies respective weights to each of the one or more attributes;
updating the respective weights associated with the one or more attributes based on feedback data associated with changes in operating permissions within a predetermined time period; and
in response to a determination, based on the updated respective weights, that a likelihood of the target user being linked to the terminated entity exceeds a second threshold indicating that an anomaly has been detected, modifying one or more operating permissions associated with the target user within a network environment.

18. The non-transitory computer readable medium of claim 17, wherein the machine learning model
generates a first embedding of a first attribute of the one or more attributes of the target user;
generates a second embedding of the first attribute of the one or more attributes of the one or more candidate users; and
determines a similarity between the first embedding and the second embedding.

19. The non-transitory computer readable medium of claim 17, wherein the one or more attributes comprise one or more unique identifiers of the target user.

20. The non-transitory computer readable medium of claim 17, wherein the machine learning model comprises a first deep learning machine model and a second machine learning model, which is trained to learn the respective weights of the one or more attributes from outputs of the first deep learning model, and the second machine learning model applies the respective weights to each of the one or more attributes.
